(19) United States
(12) Patent Application Publication
(10) Pub. No.: US 2006/0120085 A1
(43) Pub. Date: Jun. 8, 2006

(54) Lens assembly to evenly distribute projected light beams

(76) Inventors: Chi-Tang Hsieh, Chung Ho City (TW); Chan-Ching Lin, Chung Ho City (TW); Po-Laung Huang, Chung Ho City (TW)

Correspondence Address: LIN & ASSOCIATES INTELLECTUAL PROPERTY, P.O. BOX 2339, SARATOGA, CA, 95070-0339, US

(21) Appl. No.: 11/287,017

(22) Filed: Nov. 23, 2005

(30) Foreign Application Priority Data
Dec. 3, 2004 (TW) 93219516

(51) Int. Cl. F21V 5/00

(52) U.S. Cl. 362/338

(57) ABSTRACT

A lens assembly for evenly distributing light beams includes a body, an input lens and an output lens. The input lens and the output lens are oppositely mounted on the body. The input lens is a convex lens and the output lens is composed of multiple lens units arranged in such a way that a lens group is formed such that a light beam passing through the input lens and into the body is able to be evenly distributed by the output lens.

### BACKGROUND OF THE INVENTION

1. Field of the Invention

The present invention relates to a lens assembly, and more particularly to the lens assembly to evenly distribute projected light beams.

2. Description of Related Art

With reference to FIG. 1, a conventional lens assembly 10 using a blue light emitting diode (LED) chip (11) as the light source to incorporate with a yellow fluorescent powder 12 to energize the yellow fluorescent powder 12 so as to present blue light 15, which in turn energizes the yellow fluorescent matter 121 inside the yellow fluorescent powder 12 to generate the yellow light beam 16. Because blue light beam 15 and the yellow light beam 16 are complementary to each other, a white light is thus generated.

It is noted that the light beam 14 from the white light has a longer travelling distance than that of the light beam 13 inside the fluorescent powder 12 such that the light beam 14 will thus generate more yellow light. As a result, the projected light area will have a yellowish tendency outward from the center of the lighted area. Especially, when a lens is used in front of the LED light source to focus the light beams and to enhance luminosity of the lighted area, the lens will deteriorate the light distribution in the lighted area and a yellowish surroundings outside the lighted area. Therefore, it is quite difficult to use LED as the light source in compact electronic products such as PDA (personal digital assistant), cell phones or the like.

In order to overcome the shortcoming, the present invention is to provide a lens assembly to obviate the aforementioned shortcomings.

### SUMMARY OF THE INVENTION

The primary objective of the present invention is to provide a lens assembly to evenly distribute projected light so as to present harmonious luminosity.

Other objects, advantages and novel features of the invention will become more apparent from the following detailed description when taken in conjunction with the accompanying drawings.

### BRIEF DESCRIPTION OF THE DRAWINGS

FIG. 1 is a schematic view showing the light path of an LED light source passing through a fluorescent powder;

FIG. 2 is a perspective view of the lens assembly of the present invention;

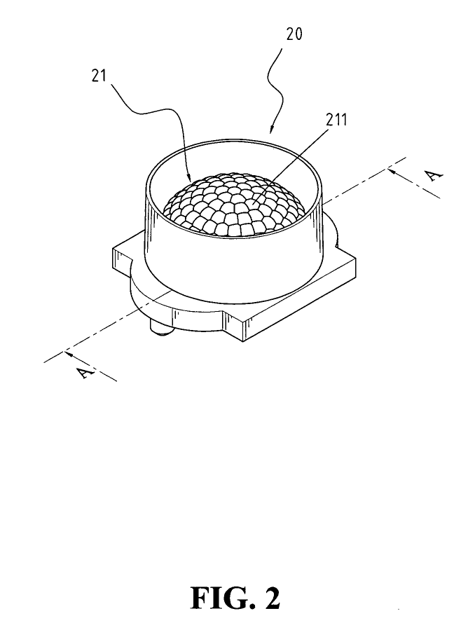

FIG. 3 is a perspective view of the lens assembly of the present invention from a different angle;

FIG. 4 is a cross sectional view taken from the line 4-4 in FIG. 2;

FIG. 5 is a schematic view showing the light path from the LED light source;

FIG. 6 is a schematic view showing a different light path from the LED light source; and

FIG. 7 is a schematic view showing the light path pattern after the light paths are mixed using the lens assembly of the present invention.

### DETAILED DESCRIPTION OF PREFERRED EMBODIMENT

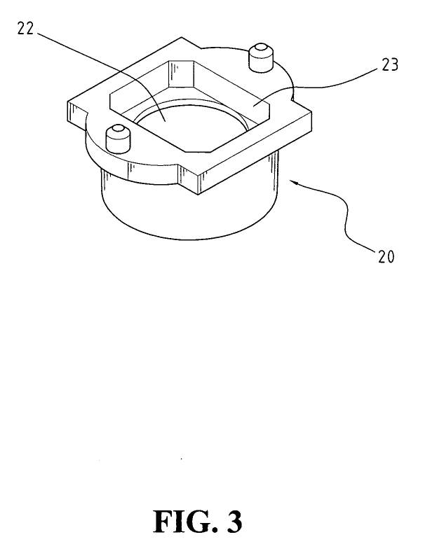

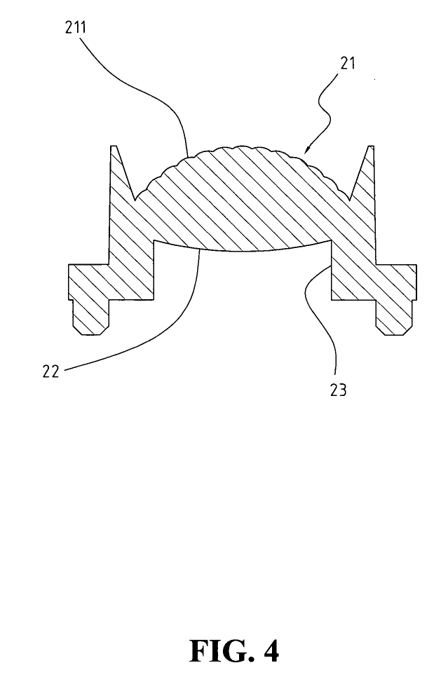

With reference to FIGS. 3 and 4, the lens assembly in accordance with the present invention includes a body 20, an input lens 22 and an output lens 21. The input lens 22 and the output lens 21 are oppositely received in the body 20. The body 20 has a chamber 23 defined to receive therein an LED light source. The output lens 21 is composed of multiple lens units 211. A light beam from the LED light source is able to pass through the input lens 22 and into the interior of the body 20 and is projected from the output lens 21 onto a predetermined subject. The LED light source is a white light LED which may be a blue light LED chip energizing YAG yellow fluorescent matter, blue light LED chip energizing the RBG (red, blue and green) fluorescent matter, a ultraviolet light LED chip energizing the RBG (red, blue and green) fluorescent matter or a combination of blue LED chip and a yellow LED chip or the combination of the blue light LED chip, the green light LED chip and the red light LED chip which are encapsulated together. Another alternative is a combination of the red light LED chip, blue light LED chip and the green light LED chip as the LED light source of the present invention.

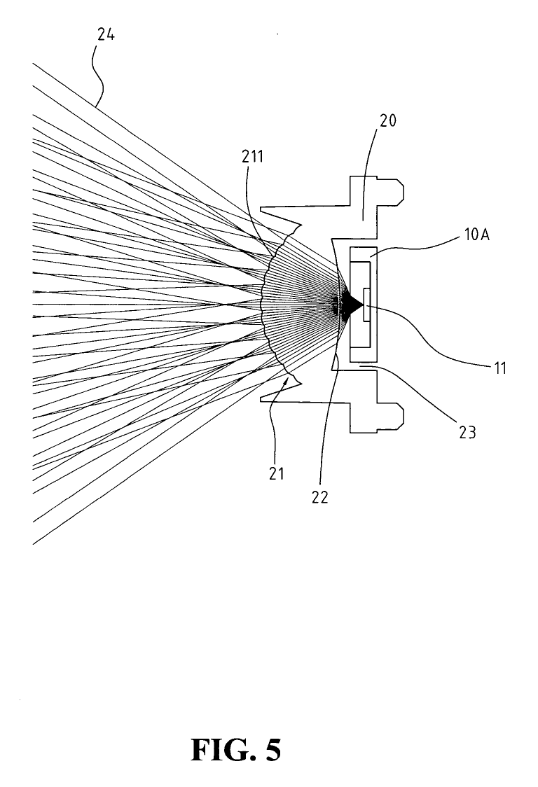

With reference to still FIG. 4, the lens units 211 are arranged to form a lens group to project the light beam evenly from the output lens 21. With reference to FIG. 5, when the lens assembly of the present invention is in application, the LED light source 10A is placed inside the chamber 23 and the blue light beam 24 from the LED chip 11 is able to pass through the input lens 22 and into the body 20. The input lens 22 may be a convex lens so that the light beam 24 from the LED chip 11 is focused and luminosity loss is reduced. Because the output lens 21 is a positive convex lens and has multiple lens units 211 which are also positive convex lenses, the light beam 24 is focused again. Thus the divergently distributed light beam will be mixed via two focusing processes. In the meantime, light beams passing over the output lens 21 is able to be distributed evenly and thus the halo problem surrounding the predetermined subject is solved.

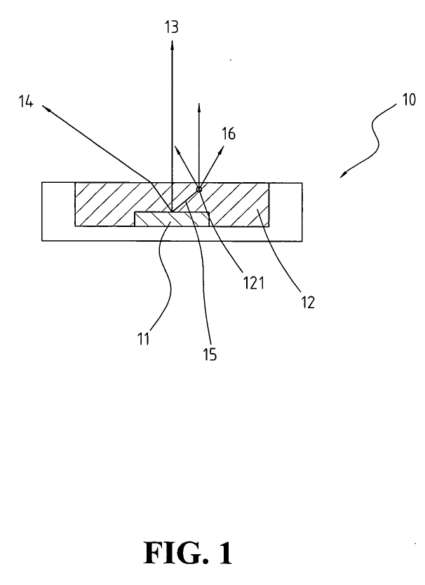

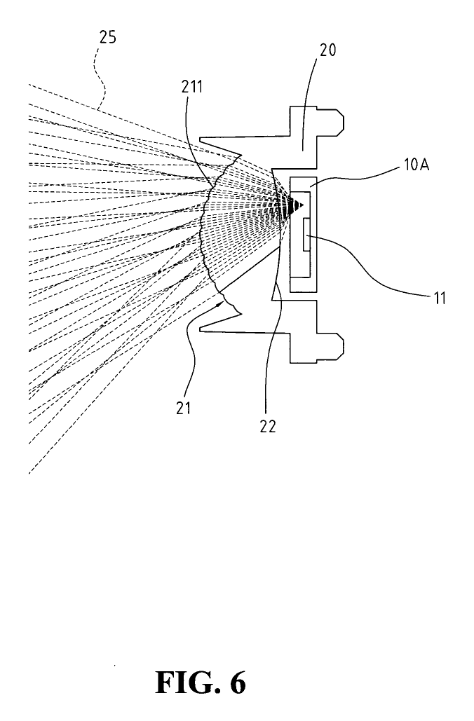

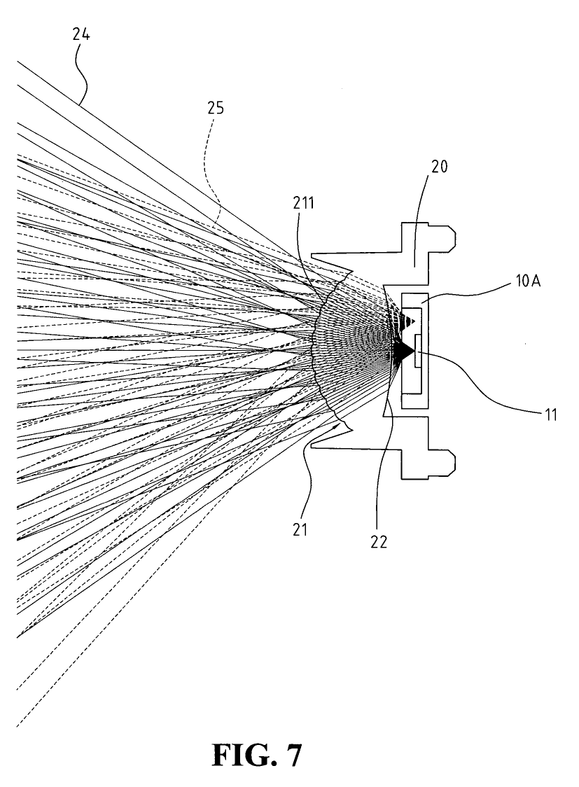

With reference to FIG. 6, it is to be noted that the blue light beam from the blue LED chip 11 is able to energize the yellow fluorescent matter in the fluorescent powder to generate yellow light beam. The yellow light beam is processed by the lens units 211 and then evenly projected. Because yellow light and blue light are complementary with respect to each other, white light is generated after the light beams are mixed by the existence of the lens units 211. With reference to FIG. 7, after the yellow light beam 25 and the blue light beam 24 are mixed by the lens units 211, even the light beam from the blue LED chip 11 travels a long distance (as the light beam 14 in FIG. 1), the light beams responsible for the yellowish halo is refracted to the center of the lens assembly and mixed with the blue light 24 to generate white light. Thus the result is that the light beams are mixed and then presented evenly.

The output lens 21 may also be a concave lens with a negative curvature. The lens unit 211 may be a lens with a positive or a negative curvature or the combination thereof. When the output lens 21 or the lens units 211 are concave lenses respectively provided with a negative curvature, the light beam passing through the input lens 22 will be scattered. However, the scattered effect is the same as that of a convex lens. That is, both the blue light beam and the yellow light beam will be evenly distributed and then mixed to generate white light. If the luminosity needs to be enhanced, it is better to use lenses with a positive curvature for both the output lens and the lens units. Furthermore, the lens units 211 may have the same curvature for both the vertical curvature and the horizontal curvature. The lens units 211 may be arranged in array, in a honeycomb or in a concentric manner.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A lens assembly for evenly distributing light beams, the lens assembly comprising a body, an input lens and an output lens, the input lens and the output lens being oppositely mounted on the body, wherein the input lens is a convex lens and the output lens is composed of multiple lens units arranged in such a way that a lens group is formed such that a light beam passing through the input lens and into the body is able to be evenly distributed by the output lens.

2. The lens assembly as claimed in claim 1, wherein the body has a chamber defined to receive therein an LED light source.

3. The lens assembly as claimed in claim 2, wherein the LED light source is a white light composed of a blue light LED chip and a yellow fluorescent powder.

4. The lens assembly as claimed in claim 1, wherein the output lens is a convex lens.

5. The lens assembly as claimed in claim 1, wherein the output lens is a concave lens.

6. The lens assembly as claimed in claim 5, wherein the lens units are convex lenses.

7. The lens assembly as claimed in claim 6, wherein each lens unit has a horizontal curvature the same as a vertical curvature thereof.

8. The lens assembly as claimed in claim 6, wherein the lens units are arranged in an array.

9. The lens assembly as claimed in claim 6, wherein the lens units are arranged in a honeycomb shape.

10. The lens assembly as claimed in claim 6, wherein the lens units are concentrically arranged.

11. The lens assembly as claimed in claim 5, wherein the lens units are convex lenses.

12. The lens assembly as claimed in claim 11, wherein each lens unit has a vertical curvature the same as a horizontal curvature thereof.

13. The lens assembly as claimed in claim 11, wherein the lens units are arranged in an array.

14. The lens assembly as claimed in claim 11, wherein the lens units are arranged in a honeycomb shape.

15. The lens assembly as claimed in claim 11, wherein the lens units are concentrically arranged.
